(19) United States
(12) Patent Application Publication
(10) Pub. No.: US 2024/0368015 A1
(43) Pub. Date: Nov. 7, 2024

(54) Method for Treating Water on Membranes Integrating Adsorption on Activated Carbon in the Form of Micrograins

(71) Applicant: Veolia Water Solutions & Technologies Support, Saint-Maurice (FR)

(72) Inventor: Philippe Sauvignet, Maen Roch (FR)

(21) Appl. No.: 18/573,168

(22) PCT Filed: Jun. 24, 2022
(86) PCT No.: PCT/EP2022/067397

§ 371 Date: Dec. 21, 2023

(30) Foreign Application Priority Data
Jun. 28, 2021 (FR) FR2106950

(51) Int. Cl. C02F 9/00; B01D 61/04; B01D 61/16; B01J 20/20; B01J 20/28; B01J 20/34; C02F 1/28; C02F 1/44; C02F 1/78; C02F 101/30; C02F 103/34

(52) U.S. Cl. CPC C02F 9/00; B01D 61/04; B01D 61/16; B01J 20/20; B01J 20/28004; B01J 20/28011; B01J 20/28061; B01J 20/28064; B01J 20/28066; B01J 20/3416; B01D 2311/04; B01D 2315/06; C02F 1/283; C02F 1/442; C02F 1/444; C02F 1/78; C02F 2101/305; C02F 2101/306; C02F 2103/343; C02F 2303/04; C02F 2303/16

(57) ABSTRACT

Method for treating water for the purpose of reducing the content of organic matter, of micropollutants and of pathogenic agents therein, comprising the supplying of water to be treated directly into a membrane reactor containing at least one filtration membrane and an adsorbent material, stirring the mixture of water and adsorbent, and extracting treated water, characterised in that the adsorbent material consists of micrograins of activated carbon having a real density of at least 0.45, a settling velocity of 30 to 50 m/H, a specific surface area of 400 to 2500 m²/g, and an average particle size of between 600 and 1300 μm, less than 5% by volume of said grains having a size of less than 400 μm, in that the concentration of said activated carbon micrograins in said membrane reactor is maintained between 5 and 100 g/L, and in that no other granular or particulate material other than the activated carbon micrograins is used in said reactor, the stirring of said mixture of water and activated carbon micrograins in the membrane reactor being at least partially carried out by air injection into said mixture at a rate of 30 to 60 Nm³/m²·H and being sufficiently vigorous to avoid the deposit of activated carbon micrograins on said at least one filtration membrane

### TECHNICAL FIELD

The present invention relates to the water treatment field.

More specifically, the invention relates to a method for treating water in order to reduce its organic matter content, including, where appropriate, its micropollutant content (pesticides, endocrine disruptors, drug residues, industrial product residues, etc.) and to eliminate pathogens (viruses, bacteria and parasites).

The method according to the invention falls within the scope of water treatment methods using a membrane reactor.

The method according to the invention is used in particular in the field of water purification, in the field of tertiary wastewater treatment and in the field of industrial-water treatment with a view to the discharge thereof into the natural environment or the reuse thereof.

### PRIOR ART

Various methods are implemented for wastewater or natural water to ensure the purification or potability thereof. Their aim is to remove all or part of the organic matter, micro-pollutants, micro-organisms and suspended solids, etc. contained therein. Such methods often involve a coagulation-flocculation step implemented in a first reactor, followed by an adsorption step on an adsorbent powder material implemented in a second reactor. According to a definition commonly accepted by those skilled in the art, powdered activated carbon (PAC) is made up of particles with an average size of between 5 μm and 50 μm, preferably between 15 μm and 25 μm. This material is commonly used as an adsorbent because of its high adsorption capacity. The PAC and coagulation-flocculation reagents are then separated from the treated water.

The coagulation-flocculation and adsorption steps considerably reduce the pollution content of the water. However, these methods require large and thus expensive infrastructure, in particular in civil engineering. Moreover, such methods involve the need to closely control the conditions in which they are implemented, in particular with regard to the concentration of PAC in the separator and to manage PAC losses in the underflow of the separator in order to minimise these losses and thus minimise the quantities of new PAC that must be added. All these factors have a negative impact on the overall efficiency of such water treatment plants and on the cost of producing treated water.

Other methods involve bringing the water to be treated in contact with the PAC and then separating the treated water from the PAC by membrane filtration. The membranes used in this context can be nanofiltration, ultrafiltration or microfiltration membranes.

Although effective, these methods have the drawback that the PAC they use blocks the pores of the membranes or forms a cake on the surface thereof. The membranes thus tend to become progressively clogged, leading to increased head loss and reduced filtration flow through the membranes, and thus increased energy consumption. Membrane clogging by the PAC, which can be partly irreversible, also tends to reduce the life of the membranes.

To prevent the clogging of submerged membranes, they must be washed regularly, mainly using chemicals such as chlorinated or alkaline solutions. However, such solutions have the drawback of being potentially harmful to the environment, and there is a need to reduce the use thereof. Moreover, they also reduce the adsorption capacity of PAC. Finally, these chemicals lead to premature ageing of the membranes.

It should also be noted that it is common practice to inject air close to the membranes in order to unclog them. One drawback of this type of technique is that the PAC tends to cause mechanical wear to the surface of the membranes, in particular when air is injected close thereto. The first consequence of this wear phenomenon is that it reduces the lifetime of the membranes and, as a corollary, filtration efficiency. These membranes must thus be replaced frequently, which involves shutting down the plants.

In order to solve this technical problem of the abrasion caused by the CAP to the filtration membranes, French patent document No. FR3015463A1 proposes using, in the membrane reactor, polymer particles with an average diameter of between 1 mm and 5 mm and a density of between 1.05 and 1.5 at a concentration of between 1 g/L and 10 g/L, and at the same time stirring the mixture of water, PAC and polymer particles in the membrane reactor.

According to this technique, the stirring of the polymer particle-containing medium in the vicinity of the membranes allows the polymer particles to create a protective screen thereon, preventing the PAC from adhering to the surface thereof. This protective screen prevents, or at the very least limits, the clogging of the pores of the membranes by the PAC and at the same time prevents the PAC from rubbing against the surface of the filtration membranes. The phenomenon of membrane wear is thus largely contained, while preventing membrane clogging.

Therefore, according to this technique, a material other than activated carbon, namely polymer particles, is used to prevent the formation of a filter cake, protect the filtration membranes and avoid direct contact between the membranes and the PAC.

It should be noted that this technique can incorporate the addition of ozone, either upstream of the membrane reactor or directly therein, for example in water potabilization systems. The interest in ozone is linked not only to the combination of the high oxidising power of ozone with the high adsorption capacity of activated carbon, but also to the accelerated decomposition of ozone into hydroxyl radicals by the activated carbon.

While this technique is highly effective, it also has a number of drawbacks.

Indeed, the drawback of using PAC is that it cannot be effectively regenerated thermally, that is to say that, according to current knowledge, under conditions that are economically feasible at the industrial stage, PAC saturated with adsorbed compounds cannot be treated in order to restore its initial adsorption capacity. Even if the PAC was adequately cleaned, for example by passing the water containing it through a hydrocyclone, and if the PAC thus cleaned was recycled, the adsorption capacity of the PAC is exhausted fairly quickly and it must be regularly replaced.

The mixture of water and spent PAC extracted from the plants in the form of sludge must undergo treatment to at least fix the pollution it contains and preferably remove it. Such treatment typically includes thickening and dewatering, which results in large quantities of solid residue. This solid residue then preferentially undergoes further treatment to break down the pollution contained therein. These various treatment steps increase the operating costs of the systems.

Moreover, even if this technique allows the number of chemical washing operations to be reduced, chemical washing of the membranes must nonetheless be carried out regularly in order to maintain membrane performance. As stated hereinabove, the quantities of chemicals used for such washing operations should be reduced for environmental reasons.

Finally, other drawbacks can be observed when this technique is used in the presence of ozone. Whether the ozone is injected into the water to be treated before it reaches the membrane reactor or whether it is directly injected into the membrane reactor, the transfer of ozone into the water is often incomplete and some ozone can be found in the head space of the membrane reactor. To protect operator health, the membrane reactor must thus be covered and an ozone destructor must be added to the vent. Moreover, to reduce the residual ozone molecules in the water leaving the ozonation reactor, a reducing agent, such as sodium bisulphite, must be added. Moreover, the physical separation of the injection and adsorption steps requires leaving the water to be treated in contact with the ozone for a long time, which creates conditions conducive to the formation of ozonation by-products, such as bromates, which start to form after 2 to 3 minutes of contact, as well as by-products derived from the organic matter present in the water, such as N-nitrosodimethylamine (NDMA). These by-products are not always adsorbable on the activated carbon particles and can build up in the water after the adsorption step. It is thus important to prevent them from forming.

### Purposes of the Invention

The present invention aims to propose a water treatment method for reducing the content of dissolved organic pollution and of micropollutants in this water by adsorption using activated carbon, which significantly reduces the quantities of new activated carbon that must be used.

The present invention further aims to propose such a method that significantly reduces the quantity of solid residue produced, such as sludge consisting of activated carbon and adsorbed matter requiring costly subsequent treatment steps, for example thickening and dewatering.

The present invention further aims to describe such a method that, in at least some of its embodiments, allows to reduce the frequency with which the membranes are washed with chemicals, thus reducing the consumption of such chemicals.

The present invention further aims to disclose such a method that, in at least some of its embodiments, allows to prevent the formation of harmful by-products resulting from ozone, thus preventing such by-products from being present in the treated water.

### DETAILED DESCRIPTION OF THE INVENTION

These various objectives, or at least some thereof, are achieved by the invention, which relates to a method for treating water for the purpose of reducing the content of organic matter, of micropollutants and of pathogenic agents, which method comprises:
a step of supplying water to be treated via a pipe directly into a membrane reactor containing at least one submerged filtration membrane,
a step of bringing said water in contact with an adsorbent material in said membrane reactor,
a step of filtering, by said at least one submerged membrane, said water containing said adsorbent material in said membrane reactor,
stirring said mixture of water and adsorbent material within said membrane reactor during said filtration step,
a step of extracting treated water,
characterised in that:
said adsorbent material consists of micrograins of activated carbon having a real density of at least 0.45, a settling velocity of 30 to 50 m/H, a specific surface area of 400 to 2500 m²/g, preferably between 1500 and 2500 m²/g, and an average particle size of between 600 and 1300 μm, less than 5% by volume of said grains having a size of less than 400 μm, in that the concentration of said activated carbon micrograins in said membrane reactor is maintained between 5 and 100 g/L, preferably between 5 and 50 g/L,
and in that no other granular or particulate material other than the activated carbon micrograins is used in said reactor,
the stirring of said mixture of water and said activated carbon micrograins in said membrane reactor during said filtration step being at least partially carried out by air injection into said mixture at a rate of 30 to 60 Nm³/m²·H and being sufficiently vigorous to avoid the deposit of activated carbon micrograins on said at least one filtration membrane.

The activated carbon micrograins used within the scope of the present invention are commercially available. In terms of particle size, they do not meet either the conventional definition of a powdered activated carbon (PAC)—which, as stated above, according to a definition commonly accepted by those skilled in the art, consists of particles with an average size of between 5 μm and 50 μm, preferably between 15 m and 25 μm-, nor the conventional definition of granular activated carbon (GAC)—which, according to a definition commonly accepted by those skilled in the art, consists of carbon particles with an average size of between 1 mm and 3 mm-. The average particle size of such micrograins is smaller than that of GAC and much larger than that of PAC. In this respect, the term “average particle size” is understood to mean the particle size relative to which 50% (by volume) of the particles are larger and 50% (by volume) of the particles are smaller.

They also have a specific surface area similar to that of PAC and greater than that of GAC, allowing for excellent adsorption of organic matter and micropollutants. They also have the advantage of being self-draining and can thus be drained very easily and very quickly, for example using simple filter bags, after being used in a mixture with water to be treated. Unlike powdered activated carbon, they also have the advantage of being easy to regenerate using methods which are generally thermal and which allow to desorb and mineralise the organic matter and micropollutants adsorbed on the surface thereof.

According to the invention, activated carbon micrograins used as an adsorbent material to adsorb organic matter surprisingly allow to avoid the need to simultaneously use polymer particles to prevent the clogging and abrasion of the organic membranes. As stated hereinabove, according to the prior art, powdered activated carbon is a material known to have the cumulative drawbacks of obstructing the pores of membranes and of causing damage thereto. A person skilled in the art was thus prompted to protect the membranes from direct contact with the activated carbon.

However, the solution herein proposed is in complete opposition to such an incentive. Indeed, according to the invention, the membranes are indeed exposed to direct contact with the activated carbon.

The inventors have observed that, surprisingly, the activated carbon micrograins selected for the implementation of the invention not only had an average size large enough not to clog the pores of the membrane, but above all that the medium consisting of the stirred mixture of water and of these micrograins did not cause them to deposit on the surface of these membranes in the form of a cake that would clog the membranes as would be expected by a person skilled in the art.

Despite the direct contact between the membranes and the activated carbon, the drawbacks of the prior art inherent in such contact do not occur in the method according to the invention. This result is achieved thanks to the features of the invention whereby the activated carbon is used in the form of micrograins with specific particle size, specific surface area, settling velocity and density properties, and whereby the mixture of water and micrograins is stirred sufficiently to prevent the activated carbon micrograins from depositing on the membranes.

It follows that, thanks to the method according to the invention, there is a far less frequent need to carry out membrane washing operations than in the techniques of the prior art and in particular that disclosed in the French patent document No. FR3015463A1.

Furthermore, as the quantities of activated carbon micrograins deposited on the membranes are very small, most of these micrograins continue to fulfil their adsorption function for a long time. As a result, savings are made on the quantities of activated carbon that must be used compared with techniques using powdered activated carbon, which activated carbon needs to be renewed less often than in these prior art methods.

Thus, thanks to the method according to the invention, the quantities of activated carbon spent and the suspended solids, which result from the washing of the membranes, that must be purged from the reactor are lower than in prior art techniques, in particular that described in the French patent document No. FR3015463A1. Moreover, unlike PAC, microgranular activated carbon can be regenerated, and the quantities of dry residue resulting from the treatment of this sludge are thus much smaller.

It should be noted that the injection of air into the reactor can be intermittent, but is preferably continuous so as to continuously contribute to maintaining the integrity of the membranes.

In one particularly advantageous embodiment of the invention, the method according to the invention further comprises a step of injecting ozone into the water passing through said pipe supplying the water to be treated to said membrane reactor, said injection step being carried out by a venturi injector.

Ozone is used to oxidise a portion of the molecules present in the water to be treated. In particular, it improves the removal of endocrine disruptors and drug residue. Ozonation also breaks down large organic molecules into smaller molecules, making them easier to adsorb and subsequently remove. Finally, ozonation can remove certain algal toxins or malodorous molecules. The inventors have also observed that, in the method according to the present invention, the addition of ozone reactivated the adsorption sites of the activated carbon micrograins, thereby helping to optimise the efficiency of this material.

According to this preferential feature of the invention, ozone is injected by the suction generated by Venturi effect, which has the advantage of preventing any leakage of ozone into the atmosphere and allows it to be mixed with the water. The Venturi effect is a suction effect generated by a moving fluid under negative pressure. The Venturi effect thus subjects the water to be treated to negative pressure, allowing the ozone to be drawn into the water. Using this technique, all of the injected ozone is incorporated and mixed into the water to be treated. Smaller quantities of ozone can thus be used, compared with techniques that are known in the prior art.

Preferably, ozone is injected at a rate of 0.5 to 10 mg/L, preferably 1 to 3 mg/L.

According to an alternative embodiment of the present invention, a step of recirculating the mixture of water and said activated carbon micrograins within said membrane reactor contributes, alongside the injection of air into the reactor, to the stirring of said mixture.

According to a preferred alternative embodiment of the invention, the concentration of said activated carbon micrograins in said membrane reactor is maintained between 5 and 100 g/L, preferably between 5 and 50 g/L.

Preferably, the method further comprises a step of extracting spent microgranular activated carbon from said reactor, a step of draining this spent activated carbon, and a step of regenerating the drained activated carbon.

The microgranular activated carbon used within the scope of the present invention has the advantage, when spent, i.e. when it is saturated with adsorbed organic matter, of being able to be freed of more than 80% of the water it contains by simple draining, and thus of having a moisture content of less than 20 wt. % after this simple draining operation. Such a simple draining operation can in particular be carried out using bags. The microgranular activated carbon thus drained can then undergo a regeneration phase, preferably thermally, in order to restore most of its original adsorption capacity and so that it can be reused within the method according to the invention. The addition of new material is thus limited, which contributes to reducing the costs of implementing the method according to the invention compared to the costs of prior art methods.

### DESCRIPTION OF AN EMBODIMENT

The method will now be described in more detail by way of the following description, which is given of a non-limiting embodiment thereof and with reference to:

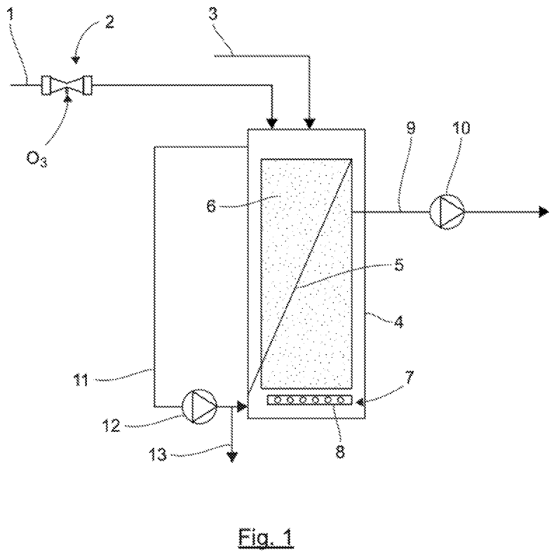

FIG. 1, which diagrammatically shows a plant for implementing the method according to the invention.

According to FIG. 1, the plant comprises a pipe 1 for supplying the water to be treated and leading into a reactor 4 housing a membrane filtration module.

Ozone injection means, more specifically a Venturi injector 2, are used to inject ozone O₃ into the pipe 1 supplying the water to be treated, in order to subject this water to an ozonation step. This ozonation step allows to oxidise the pollutants contained in the water to be treated. It further allows macromolecules to be broken up, making them easier to adsorb using an adsorbent powder material.

The filtration module contained in the reactor 4 is formed by submerged membranes 5 made of MYCRODYN BIO-CEL® organic material. It should be noted that, depending on the embodiments, the membranes can be microfiltration, ultrafiltration or nanofiltration membranes.

Means 3 for supplying an adsorbent material are provided in the top part of the reactor 4 and allow to supply therein an adsorbent material intended to adsorb the organic matter present in the water to be treated.

According to the invention, this particulate adsorbent material consists of activated carbon micrograins 6 having:
a real density of 0.45;
a settling speed of 30 to 40 m/H;
a specific surface area of 1500 to 2500 m²/g,
an average particle size of between 600 m and 1300 μm, with less than 5% of said grains having a size of less than 400 μm.

The quantity of this microgranular activated carbon present in the reactor 4 is determined in such a way that the concentration of micrograins of activated carbon in the membrane reactor 4 is between 5 g/L and 50 g/L.

The plant further comprises means 7 for injecting air into the reactor 40. These injection means in this case comprise an injection manifold 8 located in the bottom part of the reactor 4, beneath the membrane filtration module, and connected to an air supply network (not shown). Within the scope of the method according to the present invention, these means are used to supply air to the reactor 4 at a rate of 50 Nm³/m²·H. The injected air allows the granular activated carbon to be suspended in the water to be treated so that it is distributed substantially uniformly within the reactor 4, and also stirs the mixture of water and micrograins.

The combined use of activated carbon micrograins 6 and adequate stirring of the water mixture containing them on the one hand prevents these micrograins from being deposited on the membrane surface, and on the other hand gently removes any organic matter that has deposited on the surface of the membranes without causing damage thereto.

The water mixed with the activated carbon passes through the filtration module in order to separate the treated water from the activated carbon which adsorbs the organic matter present in the water. The treated water is thus discharged through a pipe 9 fitted with a pump 10.

The plant further comprises a recirculation loop 11 on which a recirculation pump 12 and a drain 13 are positioned. The drain 13 allows excess sludge, made up of microgranular activated carbon weighed down by the organic matter adsorbed thereby, to be discharged from the reactor 4.

The inlet of the recirculation pipe 11 is located in the top part of the reactor 4, whereas the outlet thereof leads into the bottom part of the reactor, thus forming a recirculation loop. This loop allows the mixture of water and microgranular activated carbon contained in the reactor to be recirculated, at least in part, within the reactor, this recirculation allowing to generate additional stirring inside the reactor.

In this embodiment, stirring inside the reactor is kept continuous.

The use of micrograins of activated carbon with the above features and correct stirring prevents damage to the membranes caused by the activated carbon and further prevents the activated carbon from being deposited in the form of a cake on the membranes. The membranes can thus undergo chemical washing less often, thus consuming smaller amounts of chemicals for this operation. The use of microgranular activated carbon leads to the production of less sludge than methods using activated carbon and polymer beads. Indeed, this microgranular activated carbon is easy to regenerate. It can also be recycled to a greater extent in the reactor by injecting ozone into the water to be treated, as this compound reactivates the adsorption sites for this material, as indicated above.

1-7. (canceled)

8. Method for treating water for the purpose of reducing the content of organic matter, of micropollutants and of pathogenic agents therein, which method comprises:
a step of supplying water to be treated via a pipe directly into a membrane reactor containing at least one submerged filtration membrane,
a step of bringing said water in contact with an adsorbent material in said membrane reactor,
a step of filtering, by said at least one submerged membrane, said water containing said adsorbent material in said membrane reactor,
stirring said mixture of water and adsorbent material within said membrane reactor during said filtration step,
a step of extracting treated water,
characterised in that:
said adsorbent material including micrograins of activated carbon having a real density of at least 0.45, a settling velocity of 30 to 50 m/H, a specific surface area of 400 to 2500 m²/g, and
an average particle size of between 600 and 1300 μm, less than 5% by volume of said grains having a size of less than 400 μm,
in that the concentration of said activated carbon micrograins in said membrane reactor is maintained between 5 and 100 g/L,
and in that no other granular or particulate material other than the activated carbon micrograins is used in said reactor,
the stirring of said mixture of water and said activated carbon micrograins in said membrane reactor during said filtration step being at least partially carried out by air injection into said mixture at a rate of 30 to 60 Nm³/m²·H and being sufficiently vigorous to avoid the deposit of activated carbon micrograins on said at least one filtration membrane.

9. Method according to claim 8, characterised in that it comprises a step of injecting ozone into the water passing through said pipe supplying the water to be treated to said membrane reactor, said injection step being carried out by a Venturi injector.

10. Method according to claim 9, characterised in that ozone is injected at a rate of 0.5 to 10 mg/L, preferably 1 to 3 mg/L.

11. Method according to claim 8, characterised in that said injection of air into the membrane reactor is continuous.

12. Method according claim 8, characterised in that said injection of air into the membrane reactor is sequenced.

13. Method according to claim 8, characterised in that it comprises a step of recirculating the mixture of water and said activated carbon micrograins within said membrane reactor contributing to the stirring of said mixture.

14. Method according to claim 8, characterised in that it comprises a step of extracting spent microgranular activated carbon from said reactor, a step of draining this spent activated carbon, and a step of regenerating the drained activated carbon.

15. Method according to claim 8, wherein said adsorbent material includes a specific service area between 1500 and 2500 m²/g.

16. Method according to claim 8, wherein the concentration of said activated carbon micrograins in said membrane reactor is maintained between 5 and 15 g/L.
